(19) United States
(12) Patent Application Publication
(10) Pub. No.: US 2019/0174955 A1
(43) Pub. Date: Jun. 13, 2019

(54) Sub Sandwich Toasting Pan

(71) Applicant: Anthony Frank DeBenedetto, Kirkland, IL (US)

(72) Inventor: Anthony Frank DeBenedetto, Kirkland, IL (US)

(21) Appl. No.: 15/840,234

(22) Filed: Dec. 13, 2017

(51) Int. Cl. A47J 37/08

(52) U.S. Cl. CPC A47J 37/0871

(57) ABSTRACT

Never before has there been a practical way to toast a sub sandwich or melt cheese on a sub sandwich both the commercial and residential setting. This pan is specially designed for this purpose, which will save time, money, and hassle for the consumer. No longer will restaurants have to rig pans in order to get their sandwiches to stand up-right. Residential people will be capable of creating perfect sub sandwiches at home with ease out of their own oven.

### CROSS-REFERENCE TO RELATED APPLICATIONS

NA

### FEDERALLY SPONSORED RESEARCH OR DEVELOPMENT

NA

### REFERENCE TO SEQUENCE LISTING, A TABLE. OR A COMPUTER PROGRAM LISTING COMPACT DISC APPENDIX

NA

### BACKGROUND OF THE INVENTION

Both in the restaurant industry and in residential use, there is not an effective way to toast the top of sub roll sandwiches. As an experienced cook and manager of my family's restaurant I find that within our restaurant and restaurants of all around that there is a common issue of effectively toasting a sandwich while not wasting product or rigging some sort of system to prevent the sandwich from falling over in the oven. This is a problem not only within the commercial industry, but also in the residential in which led me to the creation of this concept of the Sub Sandwich Toasting Pan.

### SUMMARY OF THE INVENTION

The Sub Sandwich Toasting Pan will prevent sub sandwiches from falling over by providing two channels within the pan in which two sandwiches can sit in. The sandwiches will not be able to move even with extensive movement by walking the pan to the oven. It will also be made out of cast iron as it can withstand high temperature ovens that may be used in a restaurant compared to coated pans. Being cast iron will also prevent the sandwiches from burning or sticking to the pan. It will speed up the process of toasting a sandwich by never having to spray it with non-stick coating as often used in both restaurant and residential cooking.

### DESCRIPTION OF THE SEVERAL VIEWS OF THE DRAWING

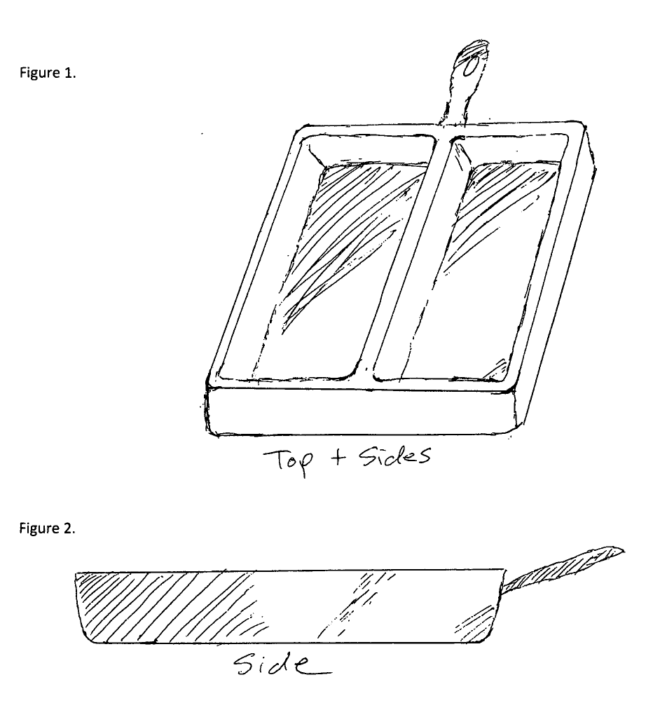

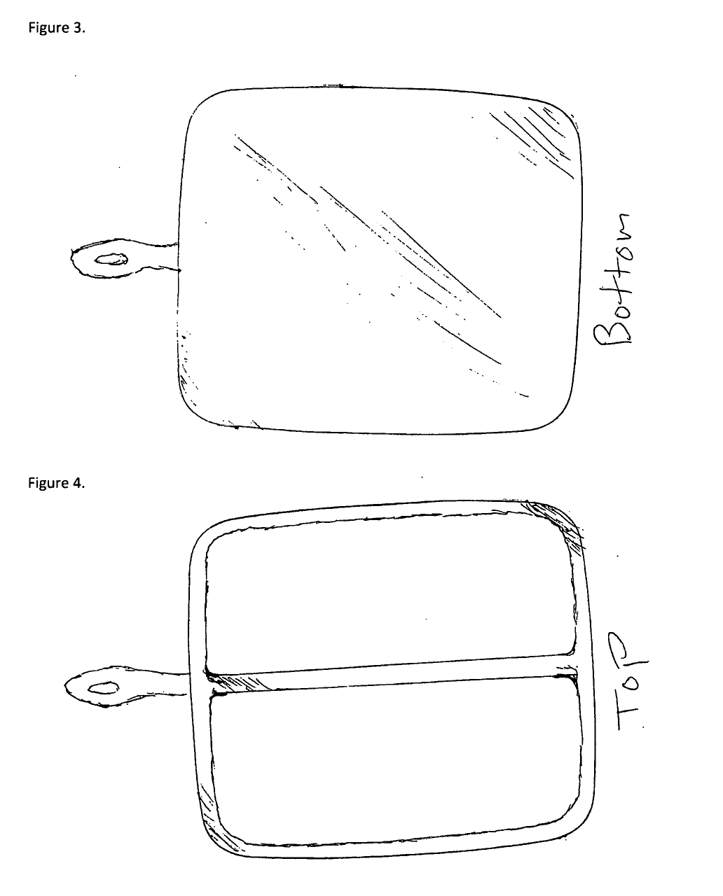

In FIG. 1, the top and sides are shown. The inside of both channels for the sandwiches to sit in can be seen. In FIG. 2, the side of the pan can be seen. The side is flat and rectangular shaped. Sticking out on the right side is the handle. In FIG. 3, the top of the pan can be seen. Both outside rims of the pan connect with the middle rim creating the two sandwich channels. FIG. 4 shows the bottom of the pan, which is simply flat and smooth so it can easily be slid in and out of the oven.

### DETAILED DESCRIPTION OF THE INVENTION

The Sub Sandwich Toasting Pan will make the future of toasting sub sandwiches both easier and faster. No longer will restaurants have to do special rigging to keep their sandwiches up-right. Residential people will be able to make restaurant quality sub sandwiches at home with ease by being able to toast buns and melt cheese to perfection on the sandwiches. Along with being completely durable with all of the rough handling in a restaurant, this pan will be safe in high temperatures and non-stick as it is cast-iron. No coated aluminum or stainless steel pan would be as non-stick or as safe as cast iron. The pan will be made with traditional methods of casting iron using a mold and pouring the liquid hot iron through it and letting in cool. The iron will then be smoothed out and pre-coated as conventional cast iron pans are. It will have a handle for easy transition in and out of the oven, which is something that today's methods of toasting a sub sandwich does not have. It will also have a flat bottom so a pizza peal can easily be used to take it out of the oven since most Italian restaurants toast sandwiches in the pizza oven. Two sandwiches will be able to be made at once as often times they are ordered in multiples at a time.

1. The Sub Sandwich Toasting Pan will be the first pan made to specifically toast sub sandwiches making it easier and faster in both the commercial and residential setting to do so.
